(19) United States
(12) Patent Application Publication
(10) Pub. No.: US 2007/0064206 A1
(43) Pub. Date: Mar. 22, 2007

(54) REAR PROJECTION DISPLAY AND ASSEMBLY METHOD FOR SAME

(75) Inventors: Jon H. Appleby, San Francisco, CA (US); Kathleen Hannon Davies, Fremont, CA (US); Paul D. Frey, San Francisco, CA (US)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: N-LIGHTEN TECHNOLOGIES, Mountain View, CA (US)

(21) Appl. No.: 11/306,374

(22) Filed: Dec. 26, 2005

Related U.S. Application Data
(60) Provisional application No. 60/719,431, filed on Sep. 21, 2005.

(51) Int. Cl. G03B 21/00

(52) U.S. Cl. 353/121; 353/119

(57) ABSTRACT

A method of manufacture of a display which creates a single axis assembly process where all components and subassemblies are added to a single part—the back bucket. The bucket is placed on an assembly line first and all other components are added to a receiving side, top down. This back bucket provides connection and alignment details for the remaining parts of the assembly, including internal electronics.

### PRIORITY REFERENCE TO PRIOR APPLICATIONS

This application claims benefit of and incorporates by reference patent application Ser. No. 60/719,431, entitled “ASSEMBLY METHOD FOR RPTVS,” filed on Sep. 21, 2005, by inventors Jon H. APPLEBY, et al.

### TECHNICAL FIELD

This invention relates generally to rear projections displays, such as televisions (TVs), and more particularly, but not exclusively, provides an assembly method for a rear projection display and a rear projection display assembled with the method.

### BACKGROUND

One of the most efficient methods for making a large display is to use projected images. Conventionally, the most advanced projection systems use imaging devices such as digital micro-mirror (DMD), Liquid Crystal on Silicon (LCoS), or transmissive LCD micro-displays. Typically, one or two fold mirrors are used in projection displays in order to fold the optical path and reorient it to reduce the cabinet depth of projection displays. In a single fold mirror rear projection display, the light engine converts digital images to optical images with one or more microdisplays, and then projects the optical image to a large mirror which relays the optical images through a rear projection screen to a viewer in front of the screen. The light engine also manages light colors to yield full color images and magnifies the image. In a two fold mirror rear projection display, the projected optical images from the light engine are reflected off of a first fold mirror to a second fold mirror, and then through the rear projection screen to a viewer. The two fold mirror structure provides additional reduction in TV cabinet depth over one fold mirror structures, but typically requires additional cabinet height below the screen. The height of the cabinet below the screen is called chin height and it grows as the light engine projects to a first fold mirror typically positioned below the screen.

Conventional Rear Projection TV (RPTV) assemblies are costly to build because they have many parts and assemblies; they are assembled from multiple directions and have not been designed efficiently from a systems approach. In part this is due to their large physical size. RPTVs that have a diagonal of 50-70 inches have a depth between 16-24 inches and as such are large clumsy boxes that are difficult to manipulate on the production line.

Due to the nonsystematic method of assembly, adding or removing components from a traditional RPTV is difficult. For example, light engine bulbs need to be replaced every three years and are often difficult to access. It is also impractical to build PC components into traditional RPTV systems as the method of assembly does not allow easy update or replacement of rapidly evolving components.

Moreover, the overall materials, labor, and capital costs associated of manufacturing traditional RPTVs are high due to the current manufacturing inefficiencies.

Accordingly, a new method of assembly is needed to overcome these deficiencies.

### SUMMARY

Embodiments of the invention provide an assembly process which significantly improves RPTV manufacturing efficiency. RPTVs are significantly thinner when assembled with the process and therefore provide easier access to internal components. In addition, RPTVs assembled with the process can calibrated and aligned through software techniques.

In an embodiment of the invention, a method of assembling a rear projection display substantially along a single axis comprises: providing a bucket with a receiving side, the single axis substantially perpendicular to a surface of the receiving side; coupling an integrated optical system to the bucket substantially along the single axis; and coupling a power supply to the optical system and the bucket substantially along the single axis.

In an embodiment of the invention, the display comprises a bucket with a receiving side; an integrated optical system having at least one mirror and a light engine, each coupled to a monolith; and a power supply. The bucket has a single axis substantially perpendicular to a surface of the receiving side. The integrated optical system is coupled to the bucket substantially along the single axis (via the monolith). The power supply is coupled to the optical system and the bucket substantially along the single axis.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A and FIG. 1B are diagrams illustrating a back bucket according to an embodiment of the invention;

FIG. 2 is a diagram illustrating sheet metal pieces installed in the bucket;

FIG. 3 is a diagram illustrating the critical components of an optical system, prior to being coupled to the bucket;

FIG. 4 is a diagram illustrating the optical system installed in the bucket;

FIG. 5 is a diagram illustrating a power supply and ballast installed in the bucket;

FIG. 6 is a diagram illustrating a front frame;

FIG. 7 is a diagram illustrating the front frame coupled to the bucket;

FIG. 8 is a diagram illustrating a front bezel;

FIG. 9 is a diagram illustrating the front bezel, a screen, and PC module coupled to the bucket;

FIG. 10 is a diagram illustrating a front door coupled to the front bezel; and

FIG. 11 is a flowchart illustrating a method of assembling a RPTV.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

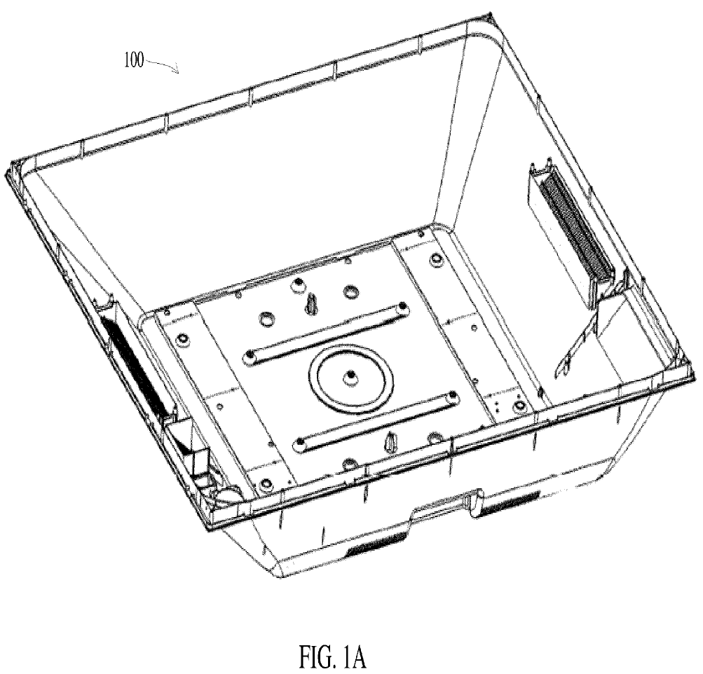

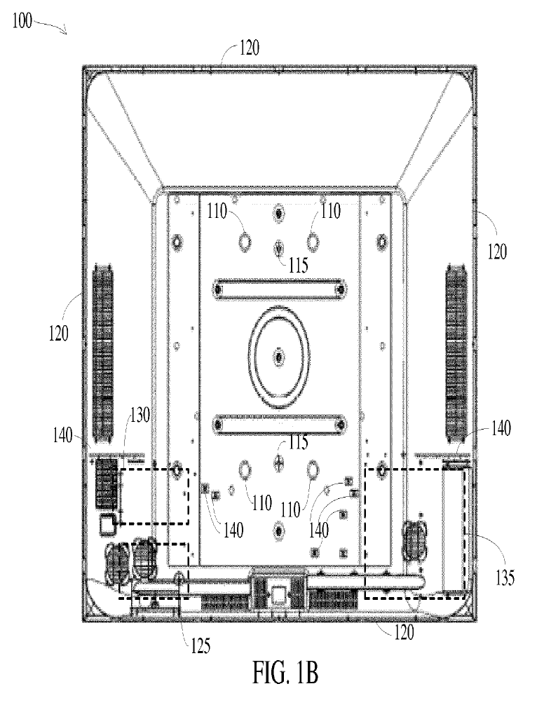

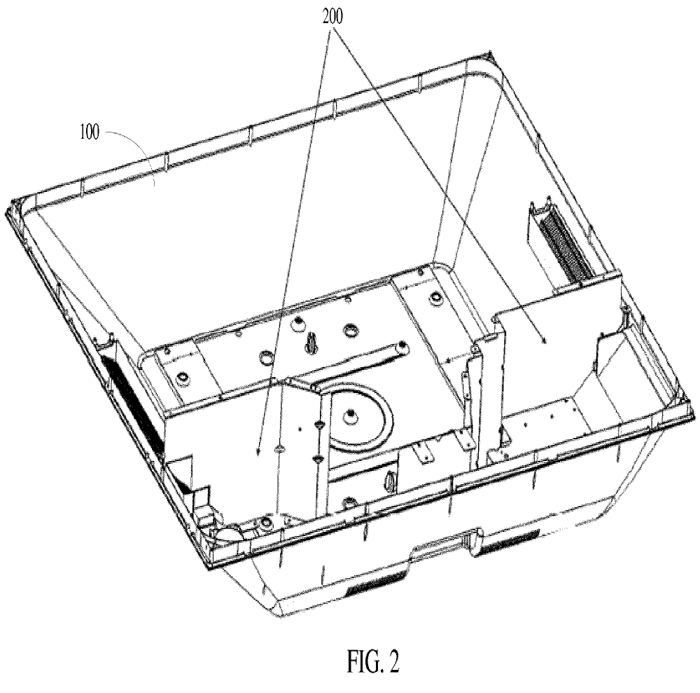

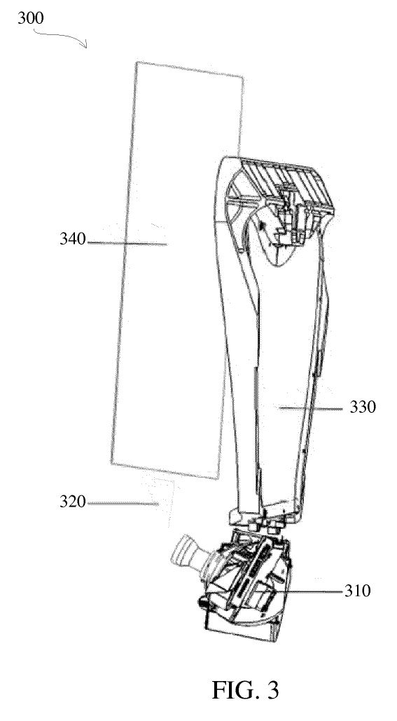

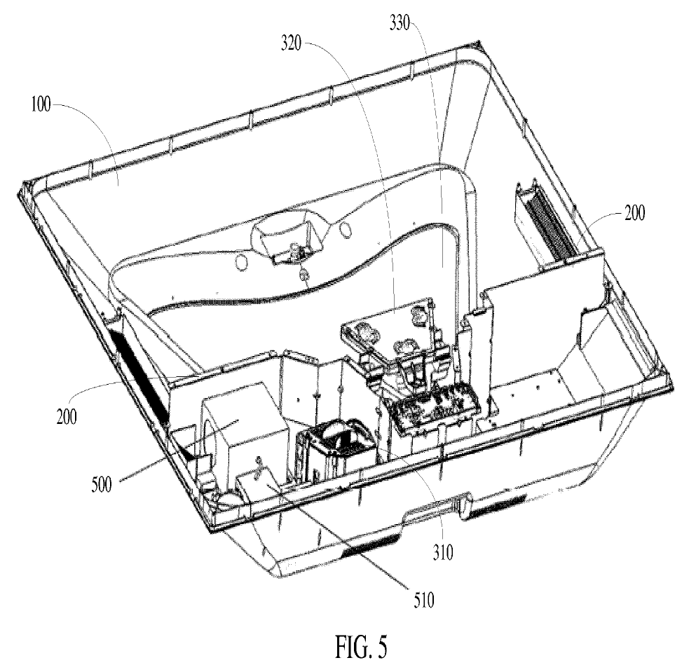

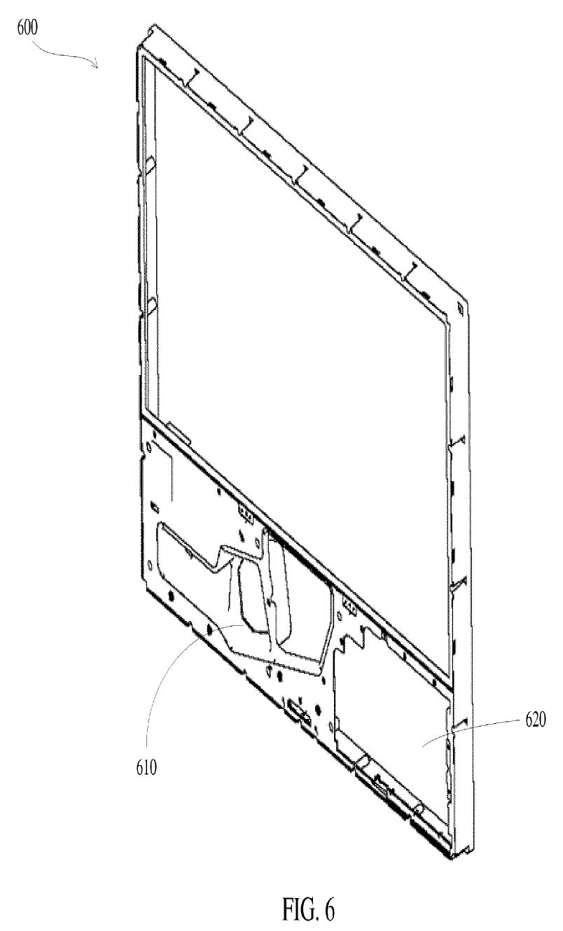

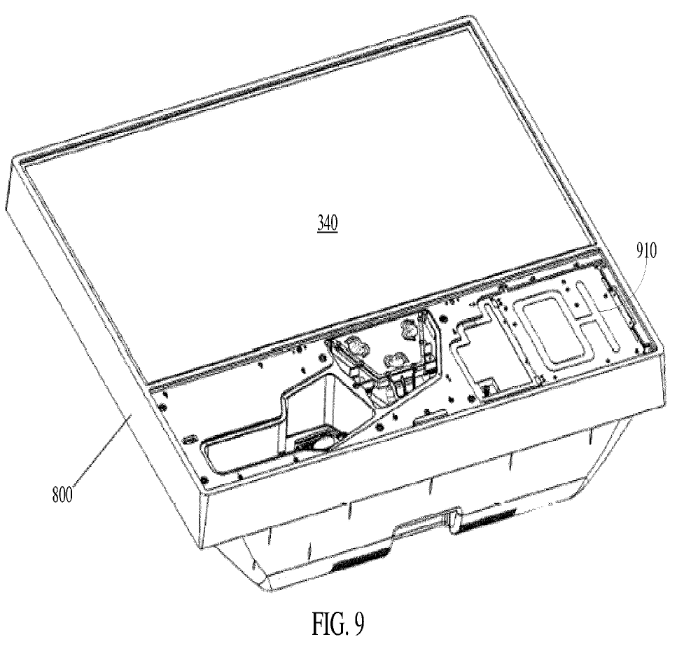

FIG. 1A and FIG. 1B are diagrams illustrating a back bucket 100 according to an embodiment of the invention. Embodiments of the invention create a single axis assembly where all components and subassemblies are added to a single part—the back bucket 100. The bucket 100 is placed on an assembly line first and all other components are added to a receiving side, top down. This back bucket 100 provides connection and alignment details for the remaining parts of the assembly, including internal electronics. In this embodiment, as shown in FIG. 1B, the back bucket 100 has bosses 110 and/or dowel pins 115 to receive and locate the pre-aligned optical system 300 (FIG. 3) (4 places), the power supply 500 (FIG. 5) (4 places) in area 130, the high voltage ballast 510 (FIG. 5) (four places) in area 125, and the PC 910 (FIG. 9) enclosure (8 places) in area 135. Attachment points 140 are used to connect the sheet metal pieces 200 (FIG. 2). Attachment points for a front frame 600 (FIG. 6) extend along a perimeter 120 of the bucket 100. The front frame 600 can also be coupled to the sheet metal pieces 200 and the PC 910 using screws.

Embodiments of the invention enable a manufacturer to assemble and test an RPTV without changing its orientation. This saves significant manufacturing time and labor. In addition, embodiments enable a manufacturer to move the finished RPTV from an assembly and test line, directly into its transportation packaging, also without changing the orientation of the RPTV. In one embodiment, the pallet or fixture that holds the back bucket 100 on the assembly line is the bottom half of the finished RPTV's protective packaging, thereby saving significant manufacturing time and labor.

The bucket 100 wraps around a rigid monolith holding optical components as described in co-pending U.S. patent application Ser. No. 11/163,995, filed Nov. 7, 2005, which is hereby incorporated by reference. The bucket 100 acts as the mounting system for the ancillary electronics, audio, power systems, and the monolith. The bucket 100 is designed to locate all of these elements in the assembly such that each has a vertical assembly path into the bucket 100.

By using the bucket 100 and monolith in the assembly process, the optical alignment is not interfered with by the bucket 100 and the bucket 100 does not contribute to the alignment of the RPTV. Therefore, handling of the bucket 100 does not contribute to misalignment, either on the production line or in the field. This increases manufacturing line efficiency and reduces field returns.

Since the bucket 100, the front bezel 800 and the front door 1010 are not part of the pre-aligned optical system 300 (FIG. 3), arbitrary designs for all these cosmetic parts are possible without modification of the optical design. This enables: late stage customization of the assembly for different internal components; late stage customization of the assembly for various external features or configurations; and late stage customization of the industrial design or appearance of the system.

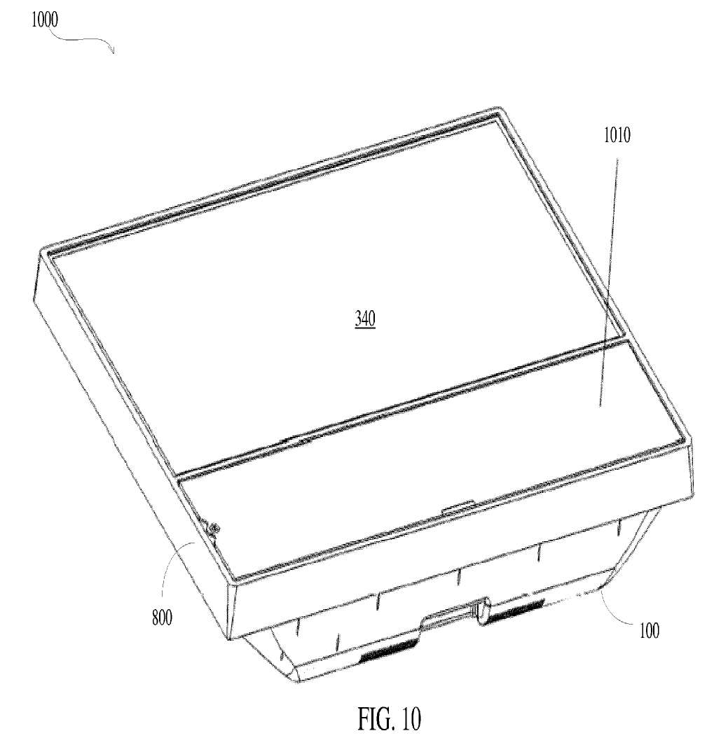

The single axis assembly method controls the position of all the components in the RPTV which allows for the following benefits:
The position of I/0 connectors and access to them is controlled so that external connections can be made to the RPTV while installed; either in a media cabinet or on the wall.
The position of a light engine 310 (FIG. 3) is controlled and the vertical assembly path allows for bulb replacement through the front of the RPTV 11000 (FIG. 10) by opening front door 1010, and accessing the bulb compartment.
This enables bulb replacement in the RPTV 1000 while installed; either in a media cabinet or on a wall.

The position of cables entering and exiting the RPTV 1000 can be controlled to provide built-in security and tamper-proofing.

Embodiments of the invention enable the efficient integration of a full personal computer 910 (FIG. 9). This integral PC 910 is possible because the vertical assembly path allows access to PC components in the finished unit. As a result, PC components and special purpose peripherals, e.g., PCI bus cards, hard drives, CD and DVD drives etc., which need to be updated regularly, can be efficiently swapped out with little impact to the production line. These items can also be easily replaced in the field, without returning units to the factory. In one embodiment this PC 910 capability is contained in a card cage structure that swings out for configuration and service. In another embodiment, the entire PC unit 910 can be removed from the unit by pulling it out like a drawer.

In one embodiment, the space relative to active screen 340 (FIG. 3) surface that houses the light system adds additional size to the unit. Since in this embodiment this space is below the screen 340, it is sometimes referred to as the “Chin”. Our method allows for the front door (1010) that covers this part of the assembly to be part of the late stage manufacturing configuration or even field replaceable. That means that the Chin can be used for multiple purposes including but not limited to: a branding surface, a product design differentiator, or advertising space.

FIG. 2 is a diagram illustrating sheet metal pieces 200 installed in the bucket 100. The sheet metal pieces 200 provide structure to stiffen the bucket 100. The pieces 200 are coupled to the bucket 100 via screws, adhesives and/or any other coupling technique. Installation of the sheet metal pieces 200 divides the bucket 100 into a bottom section that forms the chin and top section that holds the screen 340 and as such, the sheet metal pieces 200 can also be referred to as separators. The bottom section also holds the light engine 310 and electronics and as such, the pieces 200 act to block any stray light from the light engine 310 or other electronics impinging on the screen 340, thereby preventing degradation of the image. In an embodiment of the invention, the pieces 200 are made of a material other than sheet metal, e.g., plastic.

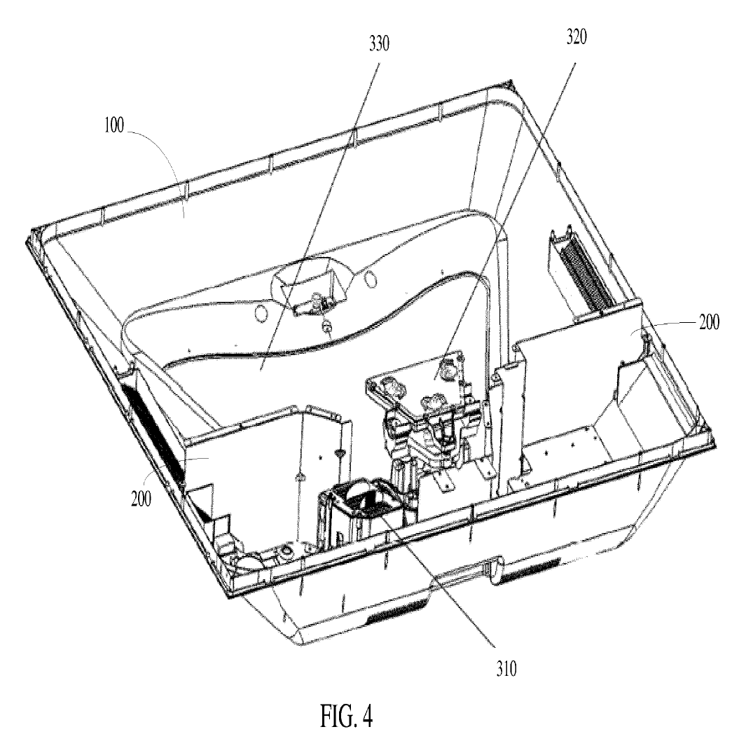

FIG. 3 is a diagram illustrating an optical system 300 for coupling to the bucket 100. Embodiments of the invention provide the assembly 300 having all optical components in a single package aligned to a single component. As such, the assembly 300 can be pre-aligned, pre-adjusted and pre-built. The assembly 300 comprises a light engine 310, a first mirror 320, a second mirror 330, all of which are coupled to a monolith. In an embodiment of the invention, the assembly 300 can also include a screen 340 that can be coupled to the monolith. The monolith is coupled to the bucket 100 by, in one embodiment, four bolts and two aligning dowel pins thereby installing the optical system 300 into the bucket 100, as shown in FIG. 4.

The light engine 310 is coupled to the monolith at a bottom section. Light projected from the engine 310 bounces off the first mirror 320, which in one embodiment is a flat steerable mirror. The light then bounces off the second mirror 330, which in one embodiment is a curved mirror fixed to a front side of the monolith (via a mirror frame in one embodiment), onto the screen 340. In an embodiment of the invention, the light engine 310 and/or the second mirror 330 are also steerable. In another embodiment, the assembly 300 includes a single mirror only, i.e., a single fold mirror rear projection display, e.g., the second mirror 330 and the light engine 310 is coupled to the monolith such that light from light engine 310 bounces off of the second mirror 330 and onto the screen 340.

FIG. 5 is a diagram illustrating a power supply 500 and ballast 510 installed in the bucket 100. The power supply 500 is coupled to and provides power to the engine 310. The ballast 510 modulates power to a lamp of the engine 310. The power supply 500 and the ballast 510 are both coupled to the bucket 100 adjacent to the metal pieces 200 such that stray light from engine 500 or ballast 510 do not impinge on the screen 340.

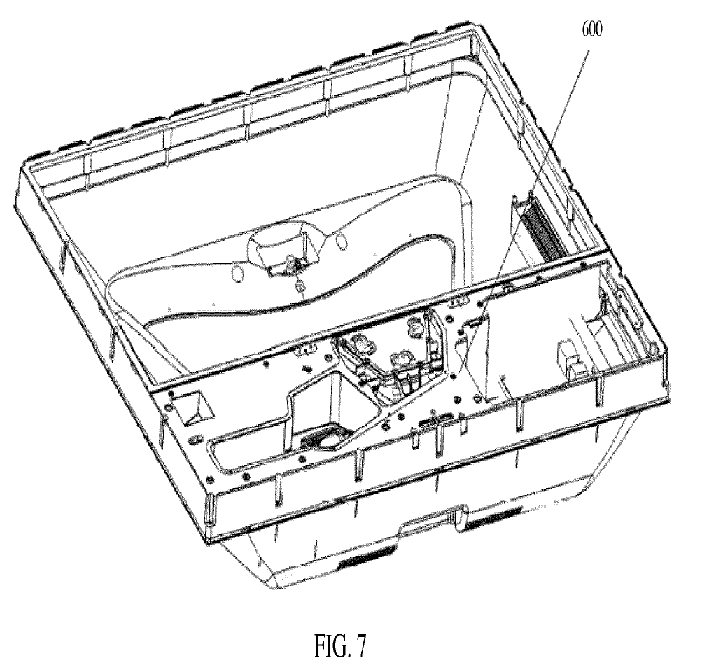

FIGS. 6 and 7 are diagrams illustrating a front frame 600. The front frame 600 is rectilinear in shape and is coupled to the bucket 100 over the previously installed components, such as the optical system 300. The front frame 600 includes access points 610 and 620 such that the engine bulb and a PC 910 (FIG. 9) can be easily accessed. The ballast 510 is high voltage and is blocked from user contact. In one embodiment, the ballast 510 cannot be accessed after the front frame 600 is attached. The front frame 600 also provides structure and rigidity to the front of the bucket 100 and in one embodiment holds the screen 340. In another embodiment, the frame does not hold the screen, but simply provides a protective frame around the screen.

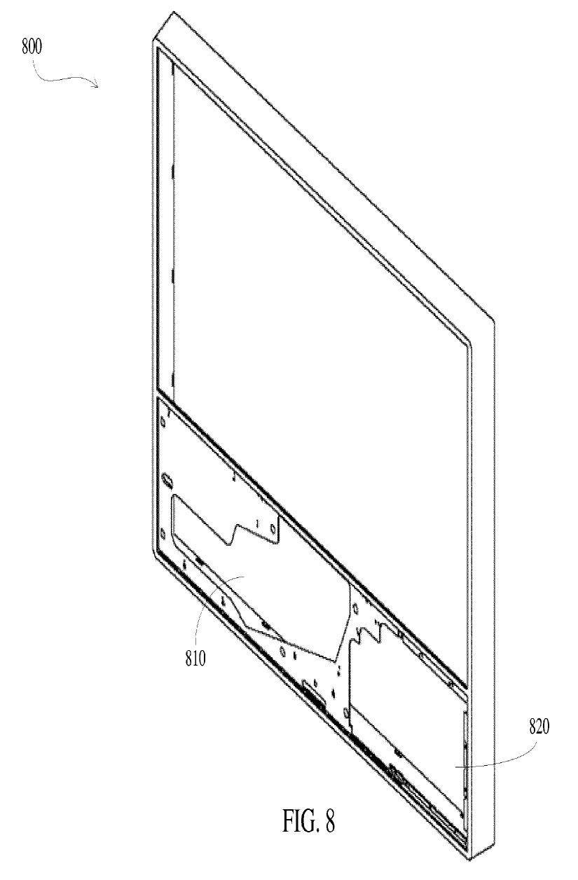

FIGS. 8 and 9 are diagrams illustrating a front bezel 800. The front bezel 800 is similarly shaped to the front frame 600 including access points 810 and 820 that correspond with access points 610 and 620 of the front frame 600. In one embodiment, the front bezel 800 sandwiches the screen 340 between the front bezel 800 and the front frame 600. Further, a PC 910 can be coupled to the bucket 100 and front frame 600 via the access point 820. The PC 910 enables a user to store and play content and to run autocorrect software.

The screen 340, can be part of the optical assembly and attached to this assembly, or can be attached to front frame 600. It is the viewing surface viewed by a user, and in one embodiment can be composed of a fresnel lens with diffuser added.

FIG. 10 is a diagram illustrating a front door 1010 coupled to the front bezel 800 to complete an RPTV 1000. Note that the RPTV 1000 is a display and is not limited to television but can be used for computers, game systems, etc. The front door 1010 covers the chin of the RPTV 1000 and is field replaceable. In an embodiment of the invention, the front door 1010 has advertising printed thereon and accordingly, advertising can be changed by changing the front door 1010. In another embodiment of the invention, the front door 1010 is translucent, thereby enabling extra light from the light engine 310 to illuminate the front door 1010 and any advertising thereon. In another embodiment of the invention, the front door 1010 includes a LCD that draws power from the power supply 500 and displays advertisements thereon.

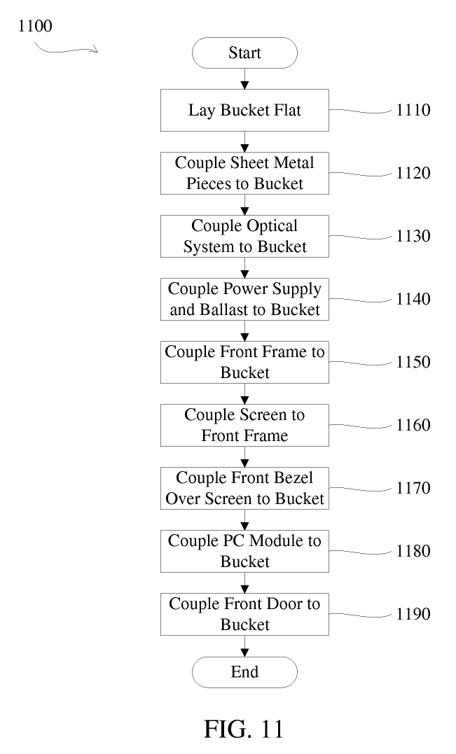

FIG. 11 is a flowchart illustrating a method 1100 of assembling the RPTV 1000. First, the bucket 100 is laid (1110) flat with the receiving side up. The sheet metal pieces are then coupled (1120) to the bucket 100. The optical system 300 is then coupled (1130) to the bucket. Next, the power supply 500 and ballast 510 are coupled (1140) to the bucket 100 and cabled to the optical system 300. The front frame 600 is then coupled (1150) to the bucket 100 and it was not part of the initial optical system, the screen 340 is then coupled (1160) to the front frame 600. The front bezel 800 is then coupled (1170) over the screen 340 to the bucket 100, thereby sandwiching the screen 340 between the front frame 600 and the front bezel 800. The PC 910 is then coupled (1180) to the bucket 100. The front door 1010 is then coupled (1190) to the front frame 600. The method 1100 then ends. In an embodiment of the invention, the method 1100 can be carried out in an order other than described above.

The foregoing description of the illustrated embodiments of the present invention is by way of example only, and other variations and modifications of the above-described embodiments and methods are possible in light of the foregoing teaching. For example, the coupling of components can be done via fasteners, adhesives and/or other coupling techniques. Further, components of this invention may be implemented using a programmed general purpose digital computer, using application specific integrated circuits, or using a network of interconnected conventional components and circuits. Data connections may be wired, wireless, modem, etc. The embodiments described herein are not intended to be exhaustive or limiting. The present invention is limited only by the following claims.

What is claimed is:

1. A method of assembling a rear projection display substantially along a single axis, the method comprising:
providing a bucket with a receiving side, the single axis substantially perpendicular to a surface of the receiving side;
coupling an integrated optical system to the bucket substantially along the single axis; and
coupling a power supply to the optical system and the bucket substantially along the single axis.

2. The method of claim 1, further comprising coupling a PC to the bucket substantially along the single axis.

3. The method of claim 2, further comprising coupling a door to below a screen substantially along the single axis, the door providing front access to the PC and an engine bulb of the integrated optical system for field replacement.

4. The method of claim 1, further comprising coupling a screen to the bucket substantially along the single axis.

5. The method of claim 4, further comprising coupling at least one separator to the bucket substantially along the single axis to prevent stray light from a light engine of the integrated optical system from hitting the screen.

6. The method of claim 1, further comprising coupling a door to below a screen substantially along the single axis, the door displaying advertising thereon.

7. The method of claim 6, wherein the door is translucent and light from the optical system illuminates the door during operation of the television.

8. The method of claim 1, wherein the integrated optical assembly includes a screen.

9. The method of claim 1, further comprising inserting the bucket into a portion of consumer packaging before the coupling of the integrated optical display system.

10. A rear projection display manufactured according to the method of claim 1.

11. A rear projection display, comprising:
a bucket with a receiving side, the bucket having a single axis substantially perpendicular to a surface of the receiving side;
an integrated optical system coupled to the bucket substantially along the single axis; and
a power supply coupled to the optical system and the bucket substantially along the single axis.

12. The display of claim 11, further comprising a PC coupled to the bucket substantially along the single axis.

13. The display of claim 12, further comprising a door coupled to below a screen substantially along the single axis, the door providing front access to the PC and an engine bulb of the integrated optical system for field replacement.

14. The display of claim 11, further comprising a screen coupled to the bucket substantially along the single axis.

15. The display of claim 14, further comprising at least one separator coupled to the bucket substantially along the single axis to prevent stray light from a light engine of the integrated optical system from hitting the screen.

16. The display of claim 11, further comprising a door coupled to a chin of the bucket substantially along the single axis, the door displaying advertising thereon.

17. The display of claim 16, wherein the door is translucent and light from the optical system illuminates the door during operation of the television.

18. The display of claim 11, wherein the integrated optical assembly includes a screen.

19. The display of claim 11, wherein the bucket is inserted into a portion of consumer packaging before manufacture of the rear projection display.

20. A bucket of a rear projection display having a receiving side configured to be coupled, substantially along a single axis perpendicular to the receiving side, to:
an integrated optical system to the bucket substantially along the single axis; and
a power supply substantially along the single axis.
